(19) United States
(12) Patent Application Publication
(10) Pub. No.: US 2002/0179870 A1
(43) Pub. Date: Dec. 5, 2002

(54) Method for reproduction of radiation image from radiation image storage panel

(75) Inventor: Hideki Suzuki, Kanagawa (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 10/158,871

(22) Filed: Jun. 3, 2002

Related U.S. Application Data
(63) Continuation of application No. 08/841,378, filed on Apr. 30, 1997, now abandoned.

(30) Foreign Application Priority Data
Apr. 30, 1996 (JP) 8-132681

(51) Int. Cl. G03B 42/08

(52) U.S. Cl. 250/584

(57) ABSTRACT

A method for reproducing a radiation image is performed by the steps of: irradiating a radiation image storage panel having a pair of transparent films and a stimulable phosphor layer arranged between them and having a radiation image recorded in the phosphor layer, with stimulating rays to release radiation energy of the radiation image as light emission; photoelectrically detecting the light emission from both sides of the radiation image storage panel to obtain electric signals; and electrically processing these electric signals to reproduce the radiation image. The stimulable phosphor layer of the radiation image storage panel is composed of a binder and stimulable phosphor particles wherein at least 50% of said stimulable phosphor particles have an aspect ration of 1.0 to 1.5.

### FIELD OF THE INVENTION

The present invention relates to a method for reproducing a radiation image from a radiation image storage panel, i.e., stimulable phosphor sheet.

### BACKGROUND OF THE INVENTION

As a method replacing a conventional radiography, a radiation image recording and reproducing method utilizing a stimulable phosphor was posed, for instance, in U.S. Pat. No. 4,239,968, and has been practically employed. In the method, a radiation image storage panel comprising a stimulable phosphor (i.e., stimulable phosphor sheet) is employed, and the method comprises the steps of causing the stimulable phosphor of the storage panel to absorb radiation energy having passed through an object or having radiated from an object; sequentially exciting the stimulable phosphor with an electromagnetic wave such as visible light or infrared rays (hereinafter referred to as “stimulating rays”) to release the radiation energy stored in the phosphor as light emission (i.e., stimulated emission); photoelectrically detecting the light emission to obtain electric signals; and reproducing the radiation image of the object as a visible image from the electric signals. The radiation image storage panel thus treated is subjected to a step for erasing a radiation image remaining therein, and then is stored for the next radiation image recording and reproducing procedure. Thus, the radiation image storage panel is repeatedly employed.

In the radiation image recording and reproducing method, a radiation image is obtainable with a sufficient amount of information by applying a radiation to an object at a considerably smaller dose, as compared with the conventional radiography using a combination of a radiographic film and radiographic intensifying screen. Further, the radiation image recording and reproducing method using a stimulable phosphor is of great value especially when the method is employed for medical diagnosis.

The radiation image storage panel employed in the above-described method has a basic structure comprising a support and a stimulable phosphor layer provided on one surface of the support. The stimulable phosphor layer generally comprises stimulable phosphor particles and a binder polymer. Further, a transparent film of polymer material is generally provided on the free surface (surface not facing the support) of the phosphor layer to keep the phosphor layer from chemical deterioration or physical shock.

In the radiation image recording and reproducing method, the radiation image recorded in the storage panel is generally read by applying the stimulating rays to one side of the storage panel and collecting light emitted by the phosphor particles by means of a light-collecting mew from the same side. There is a case, however, that the light emitted by the phosphor particles should be collected from both sides of the radiation image storage panel. For instance, there is a case that the emitted light is desired to be collected as much as possible. There also is a case that the radiation image recorded in the phosphor layer varies along the depth of the layer and such variation is desired to be detected. A typical radiation image reading system reading from both sides (hereinafter, referred to as “double-side reading system”) is illustrated in the attached FIG. 1.

In the FIG. 1, the radiation image storage panel 11 is transferred (or moved) by a combination of two sets of nip rolls 12a, 12b. The stimulating rays such as laser beam 13 is applied onto the storage panel 11 on one side, and the light emitted by the phosphor particles in the storage panel advances upward and downward (in other words, to both the upper and lower surface sides). The downward advancing light 14a is collected by a light collector 15a (arranged on the lower side), converted into an electric signal in a photoelectric conversion device (e.g., photomultiplier) 16a, mutiplied in a multiplier 17a, and then sent to a signal processor 18. On the other hand, the upwardly advancing light 14b is directly, or after reflection on a mirror 19, collected by a light collector 15b (arranged on the upper side), converted into electric signals in a photoelectric conversion device (e.g., photomultiplier ) 16b, multiplied in a multiplier 17b, and then sent to the signal processor 18. In the signal processor 18, the electric signals sent from the photoelectric conversion devices 17a, 17b are processed in a predetermined manner such as addition or reduction of the signals depending on the nature of the desired radiation image.

The radiation image storage panel 11 is further moved by means of two sets of nip rolls 12a, 12b in the direction indicated by the arrow. The surface area of the panel on which the stimulating rays 13 was applied is then set under a light source 20 such as a sodium lamp 20 for erasing radiation image remaining in the storage panel 11.

The double side-reading system adopted in the radiation image reproducing method can serve to improve the quality of reproduced radiation image, because an increased amount of the light emission which is produced from the phosphor particles by application of stimulating rays is collected from both sides of the radiation image storage panel. The double side-reading method, however, has an inherent disadvantageous feature in that the stimulating rays are applied onto the storage panel from one surface side and, therefore, the light emission collected from another surface side (back side or reverse side) is small in amount and poor in quality. The improvement of the radiation image obtained by addition or reduction between the electric signals collected from the both sides, therefore, is still not satisfactory. Particularly, it is desired to further improve the quality of radiation image such as image sharpness.

SUMMARY OF THE INVENTION

The present invention has an object to provide a radiation image reproducing method according to the double side-reading system which gives specifically improved quality such as image sharpness in the reproduced radiation image.

The present invention resides in a method for reproducing a radiation image which comprises the steps of:

irradiating a radiation image storage panel comprising a pair of transparent films and a stimulable phosphor layer intervening therebetween, said stimulable phosphor layer being composed of a binder and stimulable phosphor particles at least whose 50% (preferably at least whose 60%) in terms of number of the particles have an aspect ratio of 1.0 to 1.5, and having a radiation image thereon, with stimulating rays to release radiation energy of the radiation image as light emission;

photoelectrically detecting the light emission from both sides of the radiation image storage panel to obtain electric signals; and

electrically processing the electric signals obtained from the both sides to reproduce the radiation image.

The stimulable phosphor particles more preferably comprise at least 70% in terms of number of the particles having an aspect ratio of 3.0 to 1.7.

### BRIEF DESCRIPTION OF THE DRAWINGS

FIG. 1 schematically illustrates a radiation image reproducing method which reproduces a radiation image from a radiation image storage panel according to double-side reading system.

FIG. 2 shows a schematic section of a radiation image storage panel of the present invention.

FIG. 3 illustrates a schematic section of a radiation image storage panel of the invention in which stimulable phosphor particles of a low aspect ratio are arranged in its phosphor layer. FIG. 3 schematically illustrates further the manner of movement of light emission in the phosphor layer.

FIG. 4 illustrates a schematic section of a known radiation image storage panel in which stimulable phosphor particles of a plate shape are arranged in its phosphor layer. FIG. 4 schematically illustrates further the manner of movement of light emission in the phosphor layer.

FIG. 5 is a graph showing the aspect ratio distribution of stimulable phosphor particles which were employed in Example 1 according to the invention.

FIG. 6 is a graph showing the aspect ratio distribution of stimulable phosphor particles which were employed in Comparison Example 1.

FIG. 7 is a graph showing radiation image sharpness in terms of MTF value (%) The radiation image was reproduced from a radiation image storage panel of Example 1 or Comparison Example 1 by utilizing a double side-reading system in which light emission produced from the phosphor particles was collected from both the upper side surface and the lower side surface.

FIG. 8 is a graph showing a ratio of MTF value (Back MTF) of the radiation image reproduced from the electric signals collected from the lower side to MS value (Front MTF) of the radiation image reproduced from the electric signals collected from the upper side.

### DETAILED DESCRIPTION OF THE INVENTION

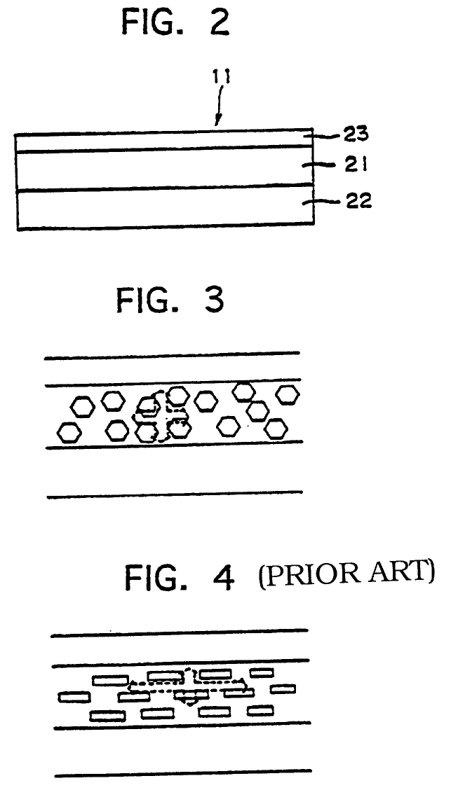

FIG. 2 schematically illustrates a section of the radiation image storage panel of the present invention. The radiation image storage panel 11 comprises a phosphor layer 21 containing stimulable phosphor particles, a transparent resin film 22 (which is relatively thick and serves as a support) arranged on one surface (on the lower or back side), and a transparent resin film 23 (which is relatively thin and serves as a protective film) arranged on another surface (on the upper or front side). One transparent film or both transparent films can be colored or processed in known manners to obviate diffusion of the stimulating rays or light emission in the lateral direction (i.e., plane direction). For the same purpose, one or plural transparent auxiliary layers such as a colored layer or a layer defining the direction of the stimulating rays or light emission can be provided in the radiation image storage panel.

FIG. 3 schematically illustrates the arrangement of stimulable phosphor particles having a low aspect ratio in the phosphor layer of the radiation image storage panel of the invention. FIG. 4 schematically illustrates the arrangement of conventionally employed plate-shaped stimulable phosphor particles in the phosphor layer of the known radiation image storage panel. In each Figure, the combined arrows indicate the directions of transmission of light emission. The long arrow indicates that the light emission is preferentially guided in that direction.

The term of “aspect ratio” of the stimulable phosphor particle is used in the invention to mean the ratio of longer diameter to shorter diameter. In the case of a plate-shaped phosphor particle, the longer diameter is the longest diameter on the plate plane, while the shorter diameter is the thickness of plate. In the case of an acicular phosphor particle, the longer diameter is the length of the acicular particle, while the shorter diameter is the thickness.

The stimulable phosphor particles of the invention have a low aspect ratio. Such stimulable phosphor particles can be particles of sphere, ellipsoid, dice (hexahedral), or polyhedral more than heptahedral such as tetradecahedral. Most preferred stimulable phosphor particles are tetradecahedral (14 faces) particles which are relatively easily produced and uniformly dispersed in the phosphor layer.

The tetradechedral phosphor particles preferably are those of rare earth activated alkaline earth metal fluorohalide phosphor which are disclosed in U.S. Pat. No. 5,534,191; issued on Jul. 9, 1996.

The rare earth activate alkaline earth metal fluorohalide phosphor in the form of tetradecahedral particles has the following formula:

Ba₁₋ₓM^{II}ₓFX:yM^{I},zLn

in which M^{II} is Sr or Ca; M^{I} is Li, Na, K, Rb or Sc; X is Cl, Br or I, Ln is Ce, Pr, Sm, Eu,, Gd, Tb, Tm or Yb; and 0<×<0.5, 0<y<0.5, and 0<z<0.2.

In the stimulable phosphor of the above formula, Ln preferably is Ce or Eu.

The stimulable phosphor gives a stimulated emission (i.e., light emission) when it is irradiated with stimulating rays after it is exposed to radiation. In the preferred radiation image storage panel, a stimulable phosphor giving a stimulated emission of a wavelength in the range of 300 to 500 nm when it is irradiated with stimulating rays of a wavelength in the range of 400 to 900 nm is employed. Examples of the preferred stimulable phosphors include divalent europium activated alkaline earth metal halide phosphors and a cerium activated alkaline earth metal halide phosphors. Both stimulable phosphors favorably give the stimulated emission of high luminance. However, the stimulable phosphors employable in the radiation image storage panel of the invention are not limited to the above-mentioned preferred stimulable phosphors.

Most of the known stimulable phosphor particles such as particles of rare earth activated alkaline earth metal fluorohalide phosphor are prepared by mixing an alkaline earth metal fluoride, an alkaline earth metal halide other than fluoride, a rare earth metal halide, and ammonium fluoride in dry state or in aqueous dispersion, calcining the mixed material, if desired, after addition of a sintering inhibitor, and pulverizing the calcined product. Thus calcined and pulverizing phosphor particles mainly comprise plate-shaped particles. When the plate-shaped phosphor particles are coated on a support in the form of a phosphor-binder polymer dispersion and dried to give a phosphor layer, the phosphor particles are apt to lie in parallel with the plane of the support in the manner as illustrated in FIG. 4. When radiation in the form of a certain image is applied onto the radiation image storage panel in which the stimulable phosphor particles are arranged in the phosphor layer in that manner to record the corresponding radiation image in the phosphor layer and the stimulating rays are applied to the phosphor layer, the stimulating rays as well as the light emission produced from the phosphor particles are apt to diffuse in the lateral direction (as illustrated in FIG. 4), and the resulting radiation image shows a relatively poor image quality, particularly, poor sharpness. The radiation image storage panel comprising the plate-shaped phosphor particles is particularly disadvantageous when the storage panel is employed in the radiation image recording and reproducing method according to the double side-reading system, because the plate-shaped phosphor particles strongly disturb the downward advancement of the light emission produced from the phosphor particles.

In contrast, the stimulating rays easily penetrate into the depth position of the radiation image storage panel comprising the phosphor particles having a low aspect ratio such as tetradecahedral phosphor particles with less diffusion in the lateral direction, and further the light emission easily advances downward with less disturbance and is efficiently collected on the lower surface side. The increase of the light emission collected on the lower side (i.e., back side) contributes improvement of quality of the radiation image reproduced by combining the light emissions collected on the upper and lower side surfaces.

The radiation image storage panel of the invention can be prepared in the following manner.

The stimulable phosphor sheet comprising a binder and stimulable phosphor particles is prepared by coating a coating dispersion comprising a binder polymer and stimulable phosphor particles in a solvent on a temporary support such as a plate of glass or polymer material, drying the coated dispersion, and recovering thus formed stimulable phosphor film from the temporary support. The stimulable phosphor sheet preferably has a thickness of 50 to 500 μm.

Examples of the binder polymers include natural polymer materials such as proteins (e.g., gelatin), polysaccharides (e.g., dextran), and gum arabic, and synthetic polymer materials such as polyvinyl butyral, polyvinyl acetate, nitrocellulose, ethyl cellulose, vinylidene chloride-vinyl chloride copolymer, polyalkyl (meth)acrylate, vinyl chloride-vinyl acetate copolymer, polyurethane, cellulose acetate butyrate, polyvinyl alcohol and linear polyester.

The phosphor sheet is then laminated on a transparent support film using an adhesive. The transparent support film preferably has a thickness of 50 to 500 μm. The transparent support film can be optionally selected from the known materials employed for the conventional radiation image storage panel. Examples of the known materials include films of plastic materials such as cellulose acetate, polyester (e.g., polyethylene phthalate), polyamide, polyimide, cellulose triacetate, and polycarbonate.

On the stimulable phosphor layer, a transparent protective film is provided.

The protective film of the invention comprises a film of plastic material and/or a coated layer of a resin composition containing a fluororesin.

The film of plastic material is optionally selected from those known as protective films of the radiation image storage panels, for instance, films of polyethylene terephthalate, polyethylene naphthalate, and aramide resin. Other plastic materials also can be employed, provided that the plastic materials have enough strength and high transparency. The thickness of the transparent protective film of plastic material generally ranges from 0.5 to 30 μm, preferably 1 to 10 μm.

The transparent protective film of the invention is preferably produced by coating the fluororesin-containing resin composition directly on the phosphor layer or on a plastic film. The coating of the fluororesin-containing resin composition on the film of plastic film can be done after the film is placed and fixed on the stimulable phosphor layer by an adhesive layer. Otherwise, the fluororesin-containing resin composition can be coated over the film of plastic material which is placed on a plane surface of an appropriate temporary support such as glass sheet. The film of plastic material which is coated with the fluororesin-containing resin composition is then placed and fixed on the stimulable phosphor layer using adhesive.

The fluororesin can be a homopolymer of a fluorine atom-containing olefin or a copolymer of a fluorine atom-containing olefin and other monomer. Examples of the fluororesins include polytetrafluoroethylene, polychloro-trifluorcethylene, polyfluorinated vinyl, polyfluorinated vinylidene, tetrafluoroethylene-hexafluoropropylene copolymer, and fluoroolefin-vinyl ether copolymer. Most of the fluororesins are insoluble in organic solvents. However, copolymers of the fluoroolefin and comonomer can be made soluble in a certain organic solvent if an appropriate comonomer is chosen. Therefore, such soluble fluororesin can be dissolved in an appropriate organic solvent to prepare a coating solution.

The above-mentioned fluororesin is employed in combination with other fluororesins or polymers other than the fluororesin to form the transparent protective layer. However, if the protective layer should have enough anti-staining properties, the layer of the resin composition should contain the fluororesin at least 30 weight %, preferably at least 50 weight %, more preferably not less than 70 weight %.

The layer of the fluororesin-containing resin mixture is preferably crosslinked to increase strength and durability of the protective layer. Accordingly, the protective layer-forming coating solution can further contain a crosslinking agent such as an isocyanate resin and an amino resin (e.g., melamine resin).

Examples embodying the present invention are given below.

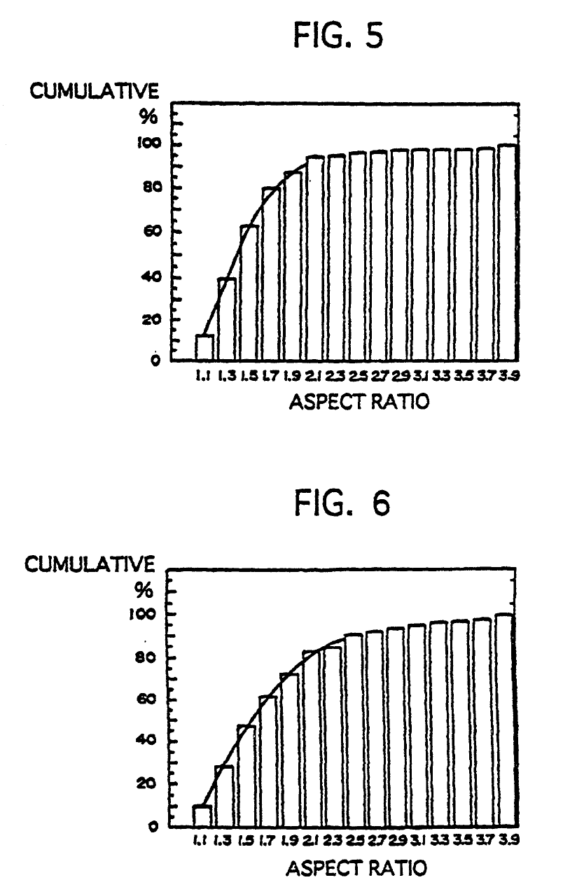

Composition

| | |
|---|---|
| Tetrahedral stimulable phosphor particles | 200 g |
| (BaFBr_{0.85}I_{0.15}: 0.005Eu²⁺, | |
| percentage of | |
| particles having an aspect ratio of | |
| 1 to 1.5: 63%, as illustrated in FIG. 5) | |
| Binder: Polyurethane elastomer (Pandex T-5275H | 7.1 g |
| (solid), product of Dai-Nippon Ink | |
| Chemical Industries Co., Ltd.) | |
| Anti-yellowing agent: Epoxy resin (Epikote | 2.0 g |
| 1007 (solid), product of Yuka Shell | |
| Epoxy Co., Ltd.) | |

### EXAMPLE 1

### [Preparation of Stimulable Phosphor Layer

### Composition

Tetrahedral stimulable phosphor particles

(BaFr_{0.85}I_{0.15}: 0.005Eu²⁺, percentage of

particles having an aspect ratio of 1 to 1.5: 63%, as illustrated in FIG. 5) 200 g Binder: Polyuxethane elastamer (Pandex T-5275H (solid), product of Dai-Nippn Ink Chemical Industries Co., Ltd.) 7.1 g Anti-yellowing agent: Epoxy resin (Epikote 1007 (solid), product of Yuka Shell Epoxy Co., Ltd.) 2.0 g

The above composition was placed in methyl ethyl ketone and dispersed by means of a propeller mixer to give a coating dispersion of a viscosity in the range of 30 PS (at 25° C.) . The coating dispersion was coated on a poly-ethylene terephthalate temporary support (180 μz) having silicone release coating. The coated layer was dried to give a stimulable phosphor sheet having a thickness of 360 μm. Thus obtained stimulable phosphor sheet was placed on a transparent polyethylene terephthalate film (PET film, thickness: 188 μm) via a transparent adhesive layer. The resulting laminate was passed through heating rollers to give a stimulable phosphor layer on the PET film.

On the stimulable phosphor layer was coated a protective layer-forming coating solution (fluororesin and isocyanate cross-linking agent in a mixture of methyl ethyl ketone and cyclohexane, 2:8, volume ratio) to form a transparent protective layer (thickness: 3 μm). Thus, there was produced a radiation image storage panel comprising a transparent support film, a stimulable phosphor sheet, and a transparent protective layer.

### Comparison Example 1

The procedures of Example 1 were repeated except for employing stimulable phosphor particles of the same chemical composition whose particle shape was not uniform, as is illustrated in FIG. 6 (percentage of particles having an aspect ratio of 1 to 1.5: 48%), to give a radiation image storage panel comprising a transparent support film, a stimulable phosphor sheet, and a transparent protective layer.

### [Evaluation of Radiation Image Storage Panel]

### (1) Procedure for Evaluation

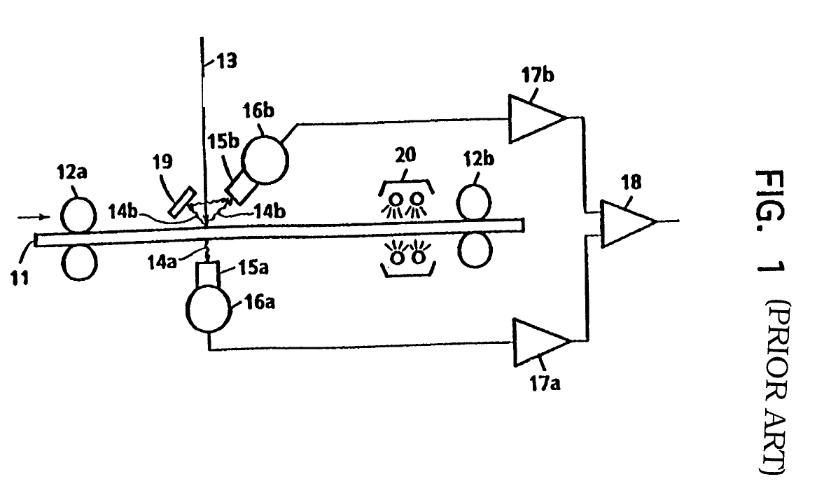

X rays (tube voltage: 80 KVp) were applied on a radiation image storage panel through an MTF chart, and the storage panel was scanned with He-Ne laser beam (wavelength: 632.8 nm) to stimulate the phosphor particles in the phosphor layer. Light emissions produced from the stimulated phosphor particles were collected by photomultipliers (sensitivity: S-5) provided on both the upper surface side and the lower surface side in the manner as illustrated in FIG. 1. The collected light emission was converted into electric signals and reproduced on a radiation image display in the form of a reproduced MTF chart image. From the reproduced MTF chart images which were obtained on the lower surface side and upper surface side, values of modulation transfer function (MTF) corresponding to varying spatial frequencies (1p/mm) were determined on each of the upper surface side and the lower surface side.

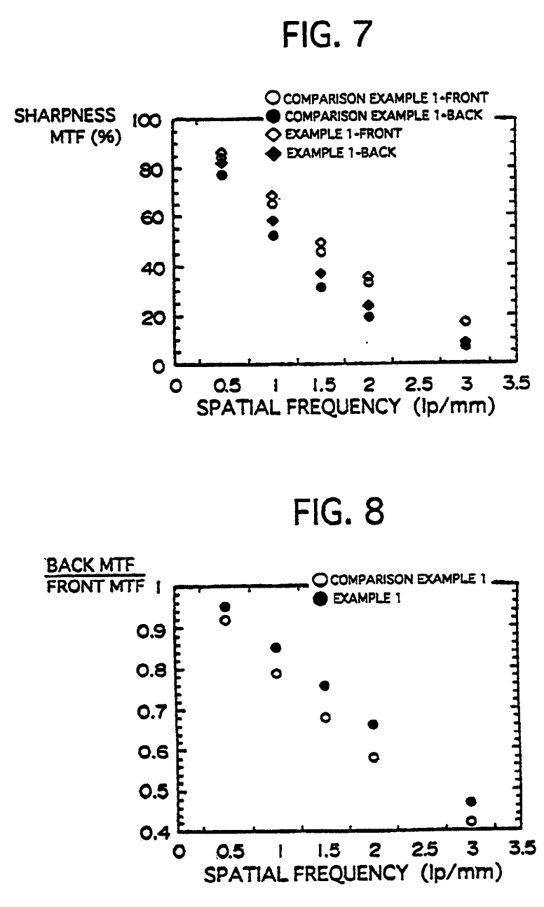

FIG. 7 graphically shows MTF values determined on each of the upper and lower surface sides of the radiation image storage panels of Example 1 and Comparison Example 1. FIG. 8 graphically shows calculated ratio of the MTF value from back side (i.e., lower surface side) to the MTF from front side (i.e., upper surface side) of the same radiation image storage panel.

### (2) Results of Evaluation

Results in FIGS. 7 and 8 indicate that the radiation image storage panel of the invention (Example (1) utilizing stimulable phosphor particles of a low aspect ratio gives a large amount of light emission on each of the upper (front) surface side and the lower (back) surface side. Accordingly, the radiation image reproduced from light emissions collected from both surface sides shows a high sharpness.

The radiation image storage panel of Comparison Example 1 utilizing plate-shaped stimulable phosphor particles also gives a large amount of light emission on the upper (front) side, but gives an extremely reduced amount of light emission on the lower (back) face side. Accordingly, the radiation image reproduced from light emissions collected from both surface sides shows a sharpness apparently lower than that of Example 1.

1. A method for reproducing a radiation image which comprises the steps of:
irradiating a radiation image storage panel comprising a pair of transparent films and a stimulable phosphor layer intervening there between with stimulating rays to release radiation energy of the radiation image as light emission, said stimulable phosphor layer having a radiation image produced thereon and being composed of a binder and stimulable phosphor particles, wherein at least 50% of said stimulable phosphor particles have an aspect ratio of 1.0 to 1.5;
photoelectrically detecting the light emission from both sides of the radiation image storage panel to obtain electric signals; and
electrically processing the electric signals obtained from the both sides to reproduce the radiation image.

2. The method of claim 1, wherein at least 60% of said stimulable phosphor particles have an aspect ratio of 1.0 to 1.5.

3. The method of claim 1, wherein at least 70% of said stimulable phosphor particles have an aspect ratio of 1.0 to 1.7.

4. The method of claim 1, wherein the stimulable phosphor particles comprise tetradecahedral rare earth metal activated alkaline earth metal fluorohalide phosphor particles.

5. The method of claim 1, wherein the pair of transparent films are composed of one transparent film having a thickness of 50 to 500 μm and another transparent film having a thickness of 1 to 10 μm.

6. The method of claim 1, wherein the pair of transparent films are composed of one transparent film having a thickness of 50 to 500 μm comprising polyester and another transparent film having a thickness of 1 to 10 μm comprising a cross-linked fluororesin.

7. The method of claim 4, wherein said tetradecahedral rare earth metal activated alkaline earth metal fluorohalide phosphor particles have the following formula:
Ba₁₋ₓM^{II}ₓFX:yM^{I}, zLn
in which M^{II} is Sr or Ca; M^{I} is Li, Na, K, Rb or Sc; X is Cl, Br or I; Ln is Ce, Pr, Sm, Eu, Gd, Tb, Tm or Yb; and 0<×<0.5, 0<y0.05, and 0<z<0.2.

8. The method of claim 7 wherein Ln is Ce or Eu.

9. The method of claim 1 wherein the binder polymer is selected from the group consisting of proteins, polysaccharides, gum arabic, polyvinyl butyral, polyvinyl acetate, nitrocellulose, ethyl cellulose, vinylidene chloride-vinyl chloride copolymer, polyalkyl (meth)acrylate, vinyl chloride-vinyl acetate copolymer, polyurethane, cellulose acetate butyrate, polyvinyl alcohol and linear polyester.
